(19) United States
(12) Patent Application Publication
(10) Pub. No.: US 2018/0099499 A1
(43) Pub. Date: Apr. 12, 2018

(54) Print Mark Sensor

(71) Applicant: SICK AG, Waldkirch (DE)

(72) Inventors: Gerhard ALT, Waldkirch (DE); Alexander BIERBAUM, Waldkirch (DE)

(21) Appl. No.: 15/723,649

(22) Filed: Oct. 3, 2017

(30) Foreign Application Priority Data
Oct. 6, 2016 (EP) 16192622.5

(51) Int. Cl. B41F 33/00; G01V 8/20; G08C 23/04

(52) U.S. Cl. CPC B41F 33/0081; B41P 2233/52; G08C 23/04; G01V 8/20

(57) ABSTRACT

A method of evaluating print marks of detection objects using a print mark sensor and a print mark sensor for evaluating print marks having at least one light transmitter and at least one light receiver having a control and evaluation unit for evaluating the light receiver signal of the light receiver and having an output for a sensor signal that is formed by the control and evaluation unit on the basis of the light receiver signal.

The present invention relates to a print mark sensor for evaluating print marks of detection objects, having at least one light transmitter and at least one light receiver, having a control and evaluation unit for evaluating a light receiver signal of the light receiver, having an output for a sensor signal that is formed by the control and evaluation unit on the basis of the light receiver signal. The invention further relates to a method evaluating print marks of detection objects using a print mark sensor.

As part of application solutions, sensors, in particular print mark sensors, mostly satisfy a specific object such as a recognition of contrast, of a color or of a pattern or a detection of a presence of an object or of the print mark. The sensor recognizes a feature and effects an action in a control via a switching signal.

It is an object of the invention to provide an improved print mark sensor that should deliver additional information to the process control beside the primary sensor signal.

The object is satisfied by a print mark sensor for evaluating print marks of detection objects having at least one light transmitter and at least one light receiver, having a control and evaluation unit for evaluating a light receiver signal of the light receiver, and having an output for a sensor signal that is formed by the control and evaluation unit on the basis of the light receiver signal, wherein an electronic memory is present to store a plurality of consecutively detected light receiver signals of a plurality of consecutively detected print marks, wherein the control and evaluation unit is configured to evaluate the plurality of light receiver signals and to generate results data and/or parameters from the time progression of these light receiver signals that enable conclusions on an environment of the print mark sensor, on the detection objects, on the print marks and/or on a process.

The object is further satisfied by a method of evaluating print marks of detection objects using a print mark sensor having at least one light transmitter for transmitting light beams and at least one light receiver for receiving remitted light beams and for evaluating a light receiver signal of the light receiver by a control and evaluation unit, wherein a sensor signal is formed by the control and evaluation unit on the basis of the light receiver signal and is output to an output, wherein a plurality of consecutively detected light receiver signals of consecutively detected print marks are stored in an electronic memory, and wherein the plurality of light receiver signals are evaluated and results data and/or parameters are generated from the time progression of these light receiver signals that enable conclusions on an environment of the print mark sensor, on the detection objects, on the print marks and/or on a process.

The light transmitter, the light receiver, and the control and evaluation unit are in this respect preferably arranged in a common housing or in a common sensor housing.

In accordance with the invention, a plurality of consecutively detected signal progressions or of characteristic values derived therefrom are recorded in operation and are put into relation with one another.

The sensor in accordance with the invention has a high-performance control and evaluation unit having sufficient processing power to be able to carry out an evaluation of the plurality of light receiver signals.

In addition to the primary sensor work, the print mark sensor can deliver further important information on its environment and/or on the process and can contribute valuable information on the operating state of the machine and on the material to be processed or also statements on the power reserves required as part of the application or use and can even deliver statements on the quality of the integration of the sensor into the total system. This information is available during the working operation or during an operating mode of the print mark sensor.

In accordance with the invention, the consecutively detected light receiver signals of a plurality of detection events can be directly evaluated in the control and evaluation unit of the print mark sensor. The original light receiver signals that have not been further filtered, reduced or already preprocessed in any other manner are thereby available to the control and evaluation unit, whereby high-quality sensor receiver signals are available.

In accordance with the invention, the consecutively detected light receiver signals also do not have to be completely transmitted to a processing unit arranged outside the sensor or outside the sensor housing.

The received light signals are, for example, detected and evaluated over hours or even over days. Slow changes of the print process, i.e. changes developing over a plurality of detection events, can thereby be recognized.

The received light signals are in this respect, for example, detected at predefined points in time or time intervals. Received light signals of print marks are thereby, for example, only detected randomly so that, for example, only every nth print mark is detected.

Provision is furthermore provided, for example, to compress the detected light receiver signal to save memory space.

A plurality of light receivers can also be provided, for example. Two light receivers are particularly preferably preferred, for example.

The electronic memory is preferably a non-volatile memory, for example a flash memory.

The print marks are frequently used in packaging machines to control the packaging process. The print marks can be black and white print marks or also color print marks.

In a further development of the invention, the results data and/or the parameters can be or are output to the output or to an additional output or to an additional interface. Virtually only light receiver signals already evaluated are thereby output as results data and/or parameters, but are smaller in comparison with the original light receiver signals from a data volume aspect and require less bandwidth on the transmission.

The results data and/or parameters can thereby be output simultaneously with the sensor signal.

The additional output or the additional interface can, for example, be an I/O link interface that enables a data exchange between the print mark sensor and a system control.

However, other electrical interfaces, bus systems, fieldbus systems, etc. can also be provided, for example.

In a further development of the invention, the results data and/or parameters can be generated continuously and can be output or are output continuously.

The results data and/or the parameters can thereby be constantly evaluated, whereby a constant monitoring of, for example, a packaging machine or printing machine is possible.

The results data and/or parameters are in this respect optionally output with a time stamp or virtually in real time so that a delay time is only present due to the processing in the control and evaluation unit.

In a special embodiment, the control and evaluation unit is configured to draw a conclusion on the real application demands with respect to the material speed, to the scanning range variations, to the signal dynamics and to influences of extraneous light and temperature from the plurality of light receiver signals.

The material speed can, for example, be detected on the basis of the detected movement of the print mark. In this respect, the light receiver signals of the print mark are e.g. detected by a plurality of receivers and the speed is determined from the time relation and can then be provided via the existing interface, for example, to the process control.

Variations of the scanning range with respect to the nominal scanning range of the sensor influence the contrast of the mark with respect to the background. This can result in a loss of detection events or in inaccuracies in the evaluation of the mark position at lower contrasts. The real extent of the scanning range variation can be determined from the receiver signals and can be put into relation with the contrasts. The measure of the scanning range variation determines the prevailing contrast and can be used to determine the functional reserve, i.e. to determine the operating safety of the sensor in the respective application.

The detected dynamic range indicates the different brightness values or the different color values in which a print mark occurs. The use of innovative packaging materials having partial design elements of high-gloss lacquers makes very high demands on the required signal dynamics that are additionally influenced by the arrangement of the sensor with respect to the object (installation angle). The time evaluation of the signals inherent to the sensor enables conclusions on the correct installation or on the correct parameterization of the sensor.

Extraneous light influences are caused, for example, by fluorescent lamps, incandescent lamps or modern LED lamps having different frequency spectra. Disturbances due to reflections or due to sunlight can, however, also represent extraneous light influences. Since extraneous light influences act the same on a print mark and the background, extraneous light influences can be derived from the receiver signals and the influence on the functional reserve can be determined. On too high a determined impairment of the detection ability, a warning can then be output via an interface, for example.

The print mark sensor can, for example, detect a temperature or evaluate temperature influences. For example, changes in the light receiver signals of the print mark can be put into relation with the detected temperature and conclusions can in particular be determined on the remaining functional reserve at temperatures close to or outside the permitted temperature limits.

In a further development of the invention, the control and evaluation unit is configured to determine correction values of the detection parameters from the plurality of light receiver signals on a machine start, during the machine operation and/or during acceleration phases or deceleration phases with respect to the detection parameters of the nominal operation. They can also be called properties of the system process. The functional reserve of the print mark sensor can thereby be increased, in particular on a machine start or on acceleration phases or deceleration phases.

In a further development of the invention, the control and evaluation unit is configured to determine a typical contrast development between a print mark and the background over a specific number of print formats from the plurality of light receiver signals. For example, deviations from a typical contrast development in a printing process can provide information on the supply of the printing ink and can be used for process control.

In a further development of the invention, the control and evaluation unit is configured to determine a measure for a homogeneity of a material to be printed from the plurality of light receiver signals.

A detected homogeneity indicates whether the carrier material to be printed is uniform in color or brightness. The carrier material is frequently used in the form of material rolls. Possible contaminants or brightness changes from the roll start to the roll end can, for example, be evaluated by the monitoring of the homogeneity and a conclusion on the quality of the carrier material can be made therefrom.

In a further development of the invention, the control and evaluation unit is configured to analyze the plurality of light receiver signals and to select a teach-in process for an application of the print mark sensor from different stored algorithms and/or to propose it to the user.

The print mark sensor is typically taught as part of a teach-in process, e.g. by a static teach-in or a 1-point teach-in or by a 2-point teach-in to mark and background. The ideal setting for the respective teaching points for the detection of the contrast relationships can change due to the real environmental and machine conditions so that after the analysis of a sufficiently large quantity of formats, i.e. after an evaluation over longer time periods, a different teaching process better suited for the conditions is offered that produces an improved detection performance of the sensor. The sensor can select suitable teaching processes better and/or suggest them to the user based on the signal evaluation.

In a further development of the invention, the control and evaluation unit is configured to determine at least one parameter from the plurality of light receiver signals and to use this parameter for optimizing a working point for a detection of print marks by changing detection parameters of the print mark sensor.

Parameters can, for example, be the values of contrast, color, material speed, temperature or also their specific time progressions. The working point of the sensor can be set again by evaluating one or more of these parameters in order thus e.g. to obtain a specific functional reserve.

This can be the case when, for example, the print image or the material speed changes according to plan or also when e.g. the environmental temperature changes.

In a further development of the invention, the control and evaluation unit is configured to determine at least one parameter from the plurality of light receiver signals, wherein the parameter is a switch-on time of a printing machine or of a packaging machine; an operating hour counter value; a ratio of switch-on time to the process time of the printing machine or packaging machine; at least one statistical value on the path speed of the print marks; a date and/or a system time of the last parameterization of the printing machine or packaging machine; a quality of the material guidance; a number of printing marks read over a defined time period; a print mark quality or a detection quality over a defined time period; a variance of a detection quality over a defined time period as an indicator for a system degradation or print mark degradation; a variance of the print mark quality over a defined time period; and/or an environmental condition value.

The switch-on time of the printing machine or packaging machine can be determined in that the time from the standstill of the recognized print mark up to the reaching of a known or uniform speed of the print marks is measured and the time is output as the switch-on time.

An operating hour counter value can be formed in that the time periods during which a movement of the print marks is recognized, for example, is measured and summed and this value is stored so that it is retained in a non-volatile manner.

The determined switch-on time can also be set into relation with a process time. That time is called the process time in which the print marks move, that is the time during which products having print marks are manufactured.

Provision can furthermore be made to determine at least one statistical value on the path speed of the print marks. It is thereby possible to carry out a statistical evaluation.

Furthermore, a date and/or a system time of the last parameterization of the printing machine or packaging machine can be stored and provided. The parameterization can, for example, be determined in that, for example, the speed of the print mark has changed. The system time is provided by a clock provided in the print mark sensor.

A number of print marks read over a defined time period can furthermore be determined by the print mark sensor. The number of products produced or the number of print marks produced can thereby be provided. An additional sensor for counting is dispensed with.

The detection quality designates the current confidence value, typically in percent, for the detection of the print mark. The certainty with which the detector has recognized a print mark is designated by this, typically as a percentage value. The detection quality is therefore updated on each detection of a print mark.

A dynamic range of the measured signal, a flank steepness of the measured signal, noise or saturation states can e.g. be taken into account for the determination of the detection quality.

A variance of the detection quality over a defined time period can furthermore be determined. In this respect, for example, information and the respective received light signals are stored for all the differently detected print marks so that a variance of the detection quality can be determined. Conclusions on the maintenance of the functional reserve can thus be determined from this.

An environmental condition value is, for example, a measured temperature, detected extraneous light, detected moisture or a detected vibration that is provided to the control and evaluation unit.

In a further development of the invention, the control and evaluation unit is configured to determine at least one parameter from the plurality of light receiver signals, wherein the parameter is a piece of information on the quality of the sensor function, wherein the parameter is a functional reserve value while taking account of environmental influences; an evaluation value of a selected teaching process with respect to alternative teaching processes; a recommendation value of a most suitable teaching process; a value on the required and/or current signal dynamics; stored error images on critical detection states; and/or an alignment of the sensor.

Unlike the detection quality, a continuously determined confidence value is determined, typically in percent, for the detection capability for the functional reserve. This therefore takes account of the possibility of a false detection in the form of both false positives and false negatives, that is of missed marks.

The dynamic range of the measured signal, a flank steepness of the measured signal, noise or saturation states can e.g. be taken into account for the determination of the functional reserve as in the detection quality.

An evaluation value of a selected teaching process with respect to alternative teaching processes can furthermore be determined and provided. For example, a determination can be made over a defined time period whether the evaluation threshold selected in a first teaching procedure was set suitably with respect to the print mark sensors or whether the threshold could be adapted better, e.g. by an alternative teaching process. The evaluation value is so-to-say a suitability value for the respective teaching process.

A recommendation value of a most suitable teaching process can be provided to a user in dependence on the determined evaluation value.

A value can furthermore be determined with respect to required and/or current signal dynamics. For example, signal dynamics are determined and a value is determined therefrom that indicates whether the signal dynamics should be improved, for example by a better sensor installation, e.g. by changing the spacing or the alignment angle.

Error images on critical detection states can furthermore be determined and stored. Error images represent a set of information that the print mark sensor can determine, for example a further parameter such as a temperature, a vibration, etc.

The print mark sensor can furthermore determine and output an alignment of the sensor itself or in relation to the print mark.

The invention will also be explained in the following with respect to further advantages and features with reference to the enclosed drawing and to embodiments. The FIGURE of the drawing shows in:

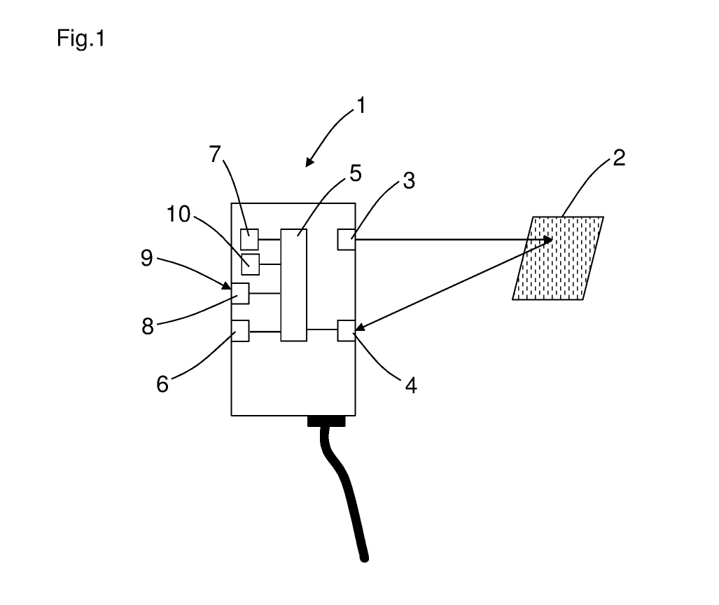

FIG. 1: a print mark sensor.

FIG. 1 shows a print mark sensor 1 for evaluating print marks 2 having at least one light transmitter 3 and at least one light receiver 4 having a control and evaluation unit 5 for evaluating the light receiver signal of the light receiver 4 and having an output 6 for a sensor signal that is formed by the control and evaluation unit 5 on the basis of the light receiver signal, wherein an electronic memory 7 is present to store a plurality of consecutively detected light receiver signals of a plurality of consecutively detected print marks, wherein the control and evaluation unit 5 is configured to evaluate the plurality of light receiver signals of a plurality of consecutively detected print marks and to generate results data and/or parameters.

The light transmitter 3, the light receiver 4, and the control and evaluation unit 5 are in this respect arranged in a common housing or in a common sensor housing.

The print mark sensor 1 is arranged, for example, at a printing machine, at a packaging machine, at a processing machine for products, etc.

The light transmitter 3 is, for example, formed by one or more light emitting diodes or laser diodes. The light receiver 4 is, for example, formed by one or more photodiodes. The print mark sensor 1 can, for example, be configured as a light sensor after which the light transmitter 3 and the light receiver 4 are arranged in a common housing in which the control and evaluation unit 5 is also arranged. The print mark sensor 1 can have further sensors 10 for detecting other environmental conditions such as temperature.

The results data and/or parameters can be output to the output 6 or to an additional output 8 or to an additional interface 9.

### REFERENCE NUMERALS

1 print mark sensor
2 print marks
3 light transmitter
4 light receiver
5 control and evaluation unit
6 output
7 memory
8 additional output
9 additional interface
10 sensor

1. A print mark sensor for evaluating print marks of detection objects, the print mark sensor having at least one light transmitter and at least one light receiver, having a control and evaluation unit for evaluating a light receiver signal of the light receiver, and having an output for a sensor signal that is formed by the control and evaluation unit on the basis of the light receiver signal, wherein an electronic memory is present to store a plurality of consecutively detected light receiver signals of a plurality of consecutively detected print marks, and wherein the control and evaluation unit is configured to evaluate the plurality of light receiver signals and to generate results data and/or parameters from the time progression of these light receiver signals that enable conclusions on an environment of the print mark sensor, on the detection objects, on the print marks and/or on a process.

2. The print mark sensor in accordance with claim 1, wherein the results data and/or parameters can be output to one of the output, an additional output and an additional interface.

3. The print mark sensor in accordance with claim 1, wherein the control and evaluation unit is configured to determine a material speed, a scanning range variation, a dynamic range, extraneous light influences and/or temperature influences from the plurality of light receiver signals.

4. The print mark sensor in accordance with claim 1, wherein the control and evaluation unit is configured to determine correction values of the detection parameters of a print mark from the plurality of light receiver signals on a machine start, during the machine operation and/or during acceleration phases or deceleration phases with respect to the nominal operation of the machine.

5. The print mark sensor in accordance with claim 1, wherein the control and evaluation unit is configured to determine a typical contrast development between a print mark and the background over a specific number of print formats from the plurality of light receiver signals.

6. The print mark sensor in accordance with claim 1, wherein the control and evaluation unit is configured to determine a measure for a homogeneity of a material to be printed from the plurality of light receiver signals.

7. The print mark sensor in accordance with claim 1, wherein the control and evaluation unit is configured to analyze the plurality of light receiver signals and to select a teaching process from different stored algorithms for an application of the print mark sensor and/or to propose it to the user.

8. The print mark sensor in accordance with claim 1, wherein the control and evaluation unit is configured to determine at least one parameter from the plurality of light receiver signals and to use this parameter for optimizing a working point for a detection of print marks by changing detection parameters of the print mark sensor.

9. The print mark sensor in accordance with claim 1, wherein the control and evaluation unit is configured to determine at least one parameter from the plurality of light receiver signals, wherein the parameter is at least one of:
a switch-on time of a printing machine or of a packaging machine;
an operating hour counter value;
a ratio of switch-on time to the process time of the printing machine or packaging machine;
at least one statistical value on the path speed of the print marks;
a date and/or a system time of the last parameterization of the printing machine or packaging machine;
a plurality of print marks read over a defined time period;
a detection quality over a defined time period;
a variance of a detection quality over a defined time period as an indicator for a system degradation or print mark degradation;
and an environmental condition value.

10. The print mark sensor in accordance with claim 1, wherein the control and evaluation unit is configured to determine at least one parameter from the plurality of light receiver signals, wherein the parameter is at least one of:
a piece of information on the quality of the sensor function,
a functional reserve value while taking account of environmental influences;
an evaluation value of a selected teaching process with respect to alternative teaching processes;
a recommendation value of a most suitable teaching process;
a value on the required and/or current signal dynamics;
stored error images on critical detection states;
and an alignment of the print mark sensor.

11. A method of evaluating print marks of detection objects using a print mark sensor having at least one light transmitter for transmitting light beams and at least one light receiver for receiving remitted light beams; the method comprising the steps of:
evaluating a light receiver signal of the light receiver signal of the light receiver by a control and evaluation unit,
forming a sensor signal by the control and evaluation unit on the basis of the light receiver signal,
outputting the sensor signal to an output,
storing a plurality of consecutively detected light receiver signals of consecutively detected print marks in an electronic memory,
wherein the plurality of light receiver signals are evaluated and results data and/or parameters are generated from the time progression of these light receiver signals that enable conclusions on an environment of the print mark sensor, on the detection objects, on the print marks and/or on a process.

12. The method in accordance with claim 11, wherein the results data and/or parameters can be output to the output or to an additional output or to an additional interface, wherein the results data can be produced continuously and can be output continuously.

13. The method in accordance with claim 11, wherein a material speed, a scanning range variation, a dynamic range, extraneous light influences and/or temperature influences are determined from the plurality of light receiver signals by the control and evaluation unit.

14. The method in accordance with claim 11, wherein a position accuracy of a print mark is determined from a plurality of light receiver signals by the control and evaluation unit on a machine start, during the machine operation and/or during acceleration phases or deceleration phases.

15. The method in accordance with claim 11, wherein a contrast development between a print mark and the background is determined by the control and evaluation unit over a specific number of print formats from the plurality of light receiver signals.

16. The method in accordance with claim 11, wherein a measure for the homogeneity of a material to be printed is determined from the plurality of light receiver signals.

17. The method in accordance with claim 11, wherein the plurality of light receiver signals are analyzed by the control and evaluation unit and a teaching process is selected from different stored algorithms for an application of the print mark sensor and/or is proposed to the user.

18. The method in accordance with claim 11, wherein at least one parameter is determined from the plurality of light receiver signals by the control and evaluation unit and this parameter is used for optimizing a working point for a detection of print marks by changing detection parameters of the print mark sensor.

19. The method in accordance with claim 11, wherein at least one parameter is determined from the plurality of light receiver signals by the control and evaluation unit, wherein the parameter
is a switch-on time of a printing machine or of a packaging machine;
is an operating hour counter value;
is a ratio of switch-on time to the process time of the printing machine or packaging machine;
is at least one statistical value on the path speed of the print marks;
is a date and/or a system time of the last parameterization of the printing machine;
is a plurality of print marks read over a defined time period;
is a detection quality over a defined time period;
is a variance of a detection quality over a defined time period as an indicator for a system degradation or print mark degradation;
is a variance of the print mark quality over a defined time period;
and/or is an environmental condition value.

20. The method in accordance with claim 11, wherein at least one parameter is determined from the plurality of light receiver signals by the control and evaluation unit, wherein the parameter is a piece of information on the quality of the sensor function of the print mark sensor, wherein the parameter
is a functional reserve value while taking account of environmental influences;
is an evaluation value of a selected teaching process with respect to alternative teaching processes;
is a recommendation value of a most suitable teaching process;
is a value on the required and/or current signal dynamics;
are stored error images on critical detection states and/or an alignment of the sensor;
and/or is an alignment of the print mark sensor.
